(19) United States
(12) Patent Application Publication
(10) Pub. No.: US 2011/0193838 A1
(43) Pub. Date: Aug. 11, 2011

(54) Driving Device, Driving Method, and Flat Panel Display

(76) Inventor: Chih-Wei Hsu, Taipei Hsien (TW)

(21) Appl. No.: 12/978,423

(22) Filed: Dec. 24, 2010

(30) Foreign Application Priority Data
Feb. 11, 2010 (TW) 099104365

(51) Int. Cl. G09G 3/36; G09G 5/00

(52) U.S. Cl. 345/207; 345/204; 345/690; 345/102

(57) ABSTRACT

A driving device for a flat panel display includes a distance detection module for detecting a distance between a base point of a housing of the flat panel display and a user, to generate a detection result, and a control module for adjusting output effects of the flat panel display according to the detection result.

### BACKGROUND OF THE INVENTION

1. Field of the Invention

The present invention relates to a driving device, driving method, and flat panel display, and more particularly, to a driving device, driving method, and flat panel display capable of avoiding visual or hearing damage, as well as reducing power consumption, to achieve energy saving and carbon reduction.

2. Description of the Prior Art

As display techniques advance, a flat panel display, such as a liquid crystal display (LCD), a plasma display panel (PDP), an organic light-emitting diode (OLED) display, etc., is developed towards a large screen size, while the price is continuously reduced. Hence, consumers are willing to purchase large-size flat panel displays as television (TV) sets, computer monitors, etc., to obtain better audio and video effects. However, as a screen size of a flat panel display increases, power consumption of the flat panel display increases. In addition, home space in a modern city is shrinking. Thus, a flat panel display with an excess screen size may be unsuitable for an actual requirement of an audio-visual environment, and may result in visual damage to users.

Therefore, how to efficiently reduce power consumption of a flat panel display, and prevent visual damage has become one of the targets in the industry.

### SUMMARY OF THE INVENTION

It is therefore an objective of the invention to provide a driving device, a driving method, and a flat panel display.

The present invention discloses a driving device for a flat panel display, which comprises a distance detection module, for detecting a distance between a base point of a housing of the flat panel display and a user, to generate a detection result, and a control module, for adjusting output effects of the flat panel display according to the detection result.

The present invention further discloses a driving method for a flat panel display, which comprises detecting a distance between a base point of a housing of the flat panel display and a user to generate a detection result, and adjusting output effects of the flat panel display according to the detection result.

The present invention further discloses a flat panel display, which comprises a housing, a monitor, a speaker, an operating device, for receiving multimedia data and outputting contents of the multimedia data via the monitor and the speaker, and a driving device. The driving device comprises a distance detection module, for detecting a distance between a base point of the housing and a user, to generate a detection result, and a control module, for controlling the operating device according to the detection result, to adjust output effects of the monitor or the speaker.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a flat panel display according to an embodiment of the present invention.

FIG. 2 is a functional block diagram of the flat panel display shown in FIG. 1.

FIG. 3 is a schematic diagram of a table used by a control module shown in FIG. 2.

FIG. 4 is a schematic diagram of a driving processing according to an embodiment of the present invention.

### DETAILED DESCRIPTION

For reducing power consumption of a flat panel display and protecting user vision, the present invention provides an adaptive and automatic display size adjusting mechanism, to properly adjust a display size according to a distance between a user and a flat panel display.

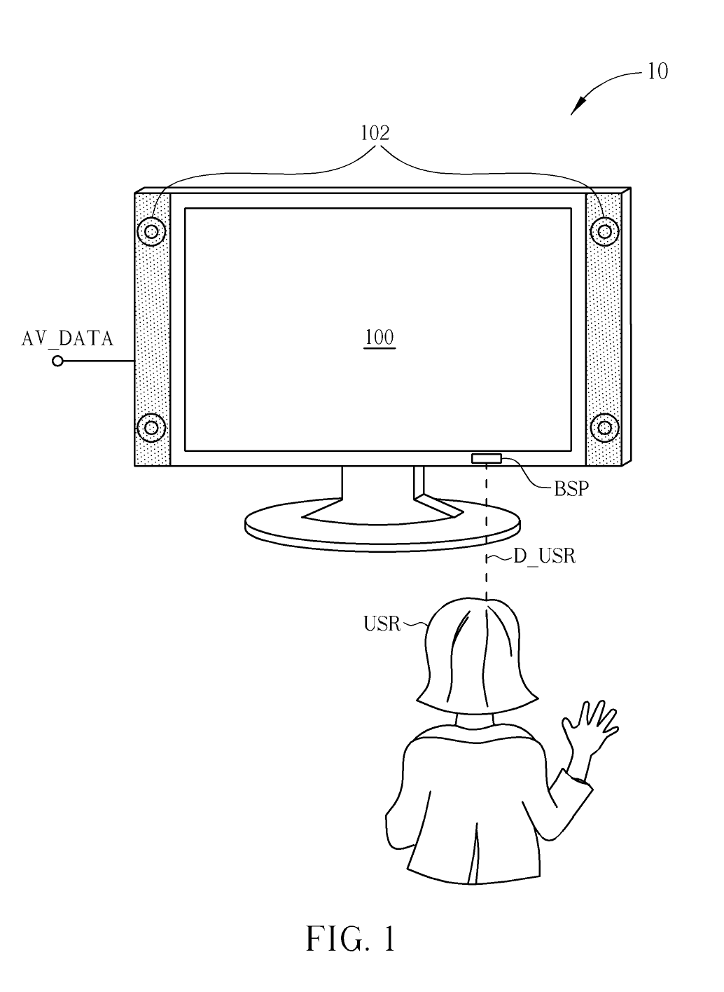

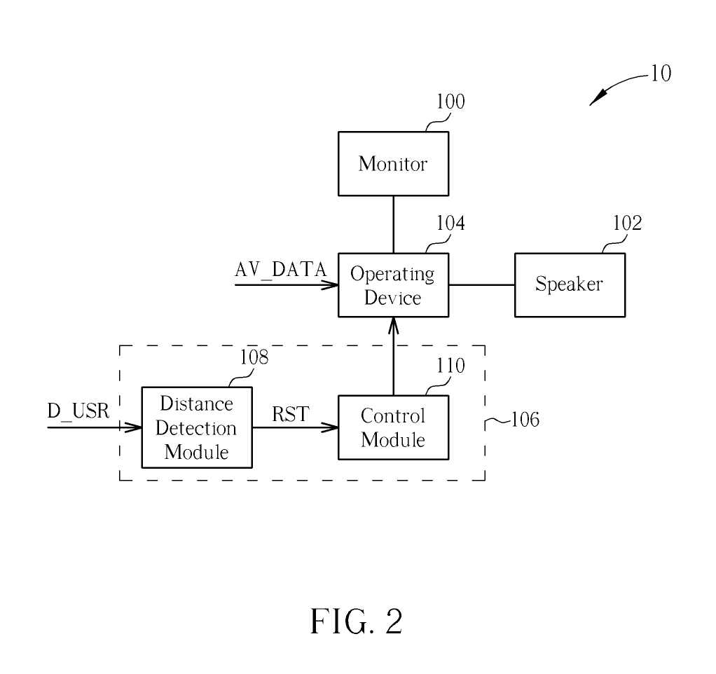

First, please refer to FIG. 1 and FIG. 2. FIG. 1 is a schematic diagram of a flat panel display 10 according to an embodiment of the present invention, and FIG. 2 is a functional block diagram of the flat panel display 10. The flat panel display 10 comprises a monitor 100, a speaker 102, an operating device 104, and a driving device 106. The operating device 104 represents a combination of software and hardware for realizing operations of the flat panel display 10, and is utilized for receiving and processing multimedia data AV_DATA, to output corresponding multimedia contents via the monitor 100 and the speaker 102. The driving device 106 comprises a distance detection module 108 and a control module 110. The distance detection module 108 is utilized for detecting a distance D_USR between a base point BSP of a housing of the flat panel display 10 and a user USR, to generate a detection result RST. According to the detection result RST outputted from the distance detection module 108, the control module 110 controls the operating device 104 to adjust output effects of the monitor 100 or the speaker 102.

Simply, the present invention adjusts the output effects of the monitor 100 or the speaker 102 according to the distance between the base point BSP and the user USR. Under such a situation, to meet different requirements, such as energy saving, comfort enhancing, etc., designers can properly adjust a display size of the monitor 100, a volume of the speaker 102, etc., according to the distance D_USR. For example, when the detection result RST indicates that the distance D_USR between the user USR and the base point BSP is greater than a predetermined value, the control module 110 can control the monitor 100 to show images with the largest display size, or increase the volume of the speaker 102. On the contrary, when the distance D_USR is smaller than the predetermined value, the control module 110 can reduce the display size of the monitor 100, e.g. to a quarter of the largest display size, or reduce the volume of the speaker 102. As a result, when the user USR is closer to the monitor 100, the control module 110 controls the operating device 104 to reduce the display size of the monitor 100, to prevent eyes of the user USR from receiving too much radiation. Meanwhile, as the display size is reduced, power consumption of the monitor 100 is decreased, such that power consumption of the whole system is decreased, to achieve energy saving and carbon reduction. In addition, when the user USR is closer to the base point BSP, the perceived volume is more obvious. Hence, the control module 110 can automatically adjust the volume of the speaker 102 within a proper range according to the distance D_USR.

Note that, FIG. 1 and FIG. 2 are utilized for illustrating embodiments of the present invention, and those skilled in the art can make modifications according to different system requirements. For example, the output effects controlled by the control module 110 are not restricted to the display size of the monitor 100 or the volume of the speaker 102, and can be brightness, contrast, hue of the monitor 100, or a treble ratio, bass ratio, loudness of the speak 102, etc. In addition, methods for adjusting the output effects of the monitor 100 or the speaker 102 are well known for those skilled in the art, and can be properly modified according to different systems. For example, the display size of the monitor 100 can be adjusted via a coordinate conversion, to switch the display size from full-screen to others.

Moreover, for reaching energy saving, operating methods should be properly modified according to system architectures. For example, while the monitor 100 is implemented by an LCD monitor, since the LCD monitor requires a backlight module to provide backlights, backlights of unused regions (which do not show images) can be turned off after the display size is reduced. More specifically, if the backlight module is composed of a plurality of cold cathode fluorescent lamps (CCFLs), the above-mentioned operation can be done by switching off CCFLs corresponding to the unused regions. If the backlight module is composed of a plurality of light-emitting diodes (LEDs), LEDs corresponding to the unused regions can be turned off. Furthermore, while the monitor 100 is implemented by an LCD monitor, thin-film transistors (TFTs) of the unused regions can be turned off after the display size is reduced, to further reduce power consumption.

In addition, while the monitor 100 is implemented by a self-luminous monitor, such as a plasma display monitor, an organic light-emitting diode monitor, etc., since display units of this kind of monitors demonstrate the corresponding pixels via self-luminous processes, display units of the unused regions do not consume power after the display size is reduced.

Implementation methods of the distance detection module 108 are not restricted, as long as the distance D_USR can be accurately detected. For example, the distance detection module 108 can be an infrared detector, for sensing thermals of the user USR at the base point BSP via an infrared sensing method, so as to detect the distance D_USR between the base point BSP and the user USR. The distance detection module 108 can be an electromagnetic energy detector, for sensing electromagnetic energy of the user USR at the base point BSP via an electromagnetic sensing method, to detect the distance D_USR between the base point BSP and the user USR. The distance detection module 108 can be an optical detector, for sensing optical reflections or fluctuations of the user USR at the base point BSP via an optical sensing method, to detect the distance D_USR between the base point BSP and the user USR. In addition, the distance detection module 108 can comprise a plurality of elements, such as an ultrasonic transmitter and an ultrasonic detector. The ultrasonic transmitter is utilized for transmitting an ultrasonic signal to the user USR, and the ultrasonic detector is utilized for receiving reflection signals of the user USR at the base point BSP via an ultrasonic sensing method, so as to detect the distance D_USR between the base point BSP and the user USR. Furthermore, algorithms applied by the distance detection module 108 are not restricted. For example, the distance detection module 108 can have three detectors to determine the distance D_USR via a triangulation method.

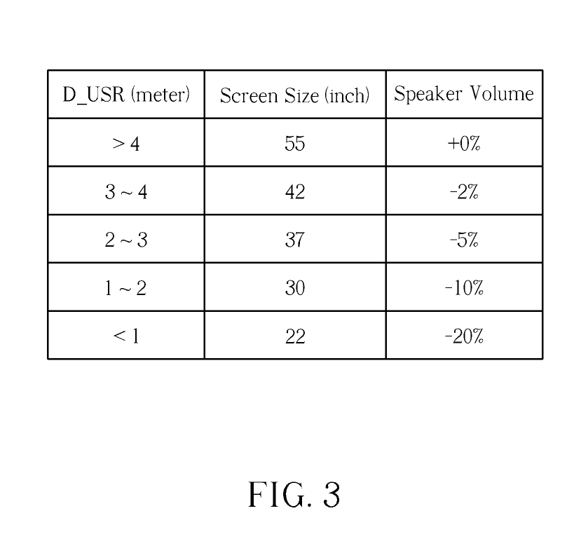

The control module 110 controls the operating device 104 to adjust the output effects of the monitor 100 or the speaker 102 according to the detection result RST. In order to avoid frequent adjustments, a plurality of adjusting intervals can be properly established. For example, if the size of the monitor 100 is 55 inches, the control module 110 can adjust the display size of the monitor 100 or the volume of the speaker 102 according to a table shown in FIG. 3. As shown in FIG. 3, when the distance D_USR between the base point BSP and the user USR is greater than 4 meters, the control module 110 controls the monitor 100 to operate in a full-screen display size, and does not adjust the volume of the speaker 102. When the distance D_USR is between 3 meters and 4 meters, the control module 110 controls the monitor 100 to operate in a 42-inch display size, and reduces the volume of the speaker 102 by 2%. When the distance D_USR is between 2 meters and 3 meters, the control module 110 controls the monitor 100 to operate in a 37-inch display size, and reduces the volume of the speaker 102 by 5%. When the distance D_USR is between 1 meter and 2 meters, the control module 110 controls the monitor 100 to operate in a 30-inch display size, and reduces the volume of the speaker 102 by 10%. And, when the distance D_USR is less than 1 meter, the control module 110 controls the monitor 100 to operate in a 22-inch display size, and reduces the volume of the speaker 102 by 20%.

Note that, FIG. 3 is the table shown for illustrating the concept of the present invention, and other adjusting methods or items can be included. For example, a time checking mechanism can be included; that is, the control module 110 performs adjustment after the distance D_USR changes to a different interval for a predetermined duration. For example, after the distance D_USR changes from the interval greater than 4 meters to the interval between 2 meters and 3 meters for 15 seconds, the control module 110 starts to control the monitor 100 to operate in the 37-inch display size, and reduce the volume of the speaker 102 by 5%.

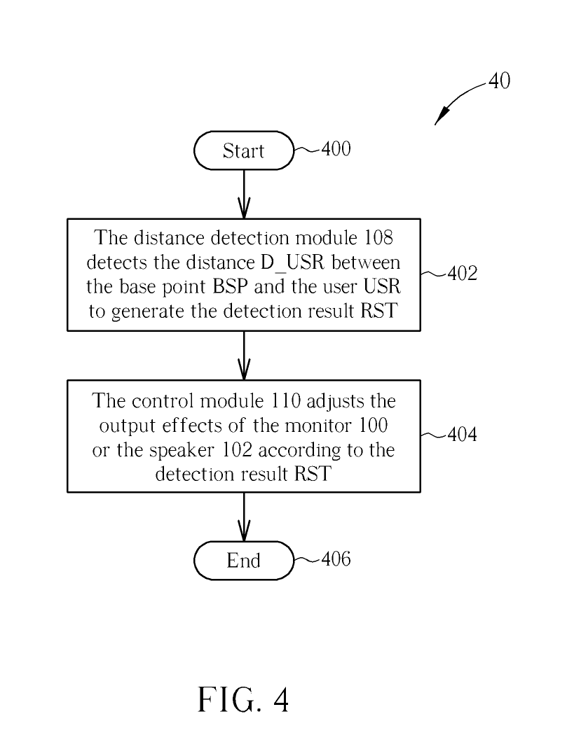

Operations of the driving device 106 described above can further be concluded into a driving processing 40, as shown in FIG. 4. The driving processing 40 comprises the following steps:

Step 400: Start.

Step 402: The distance detection module 108 detects the distance D_USR between the base point BSP and the user USR, to generate the detection result RST.

Step 404: The control module 110 adjusts the output effects of the monitor 100 or the speaker 102 according to the detection result RST.

Step 406: End.

Details of the driving processing 40 can be referred in the above, and thus are not further narrated herein.

In the prior art, an excess display size is not suitable for an actual requirement of an audio-visual environment, and may result in visual damage to the user and unnecessary power consumption. In comparison, the present invention can properly adjust the output effects of the flat panel display, such as display size, volume, etc., according to the distance between the user and the flat panel display, to prevent visual or hearing damage, reduce power consumption, and achieve energy saving and carbon reduction.

To sum up, the present invention adjusts the output effects of the monitor or the speaker according to the distance between the user and the flat panel display, to avoid visual or hearing damage, reduce power consumption, and achieve energy saving and carbon reduction.

Those skilled in the art will readily observe that numerous modifications and alterations of the device and method may be made while retaining the teachings of the invention.

What is claimed is:

1. A driving device for a flat panel display, comprising:
a distance detection module, for detecting a distance between a base point of a housing of the flat panel display and a user, to generate a detection result; and
a control module, for adjusting output effects of the flat panel display according to the detection result.

2. The driving device of claim 1, wherein the distance detection module is an infrared detector, for sensing thermals of the user at the base point via an infrared sensing method, to detect the distance between the base point and the user.

3. The driving device of claim 1, wherein the distance detection module comprises:
an ultrasonic transmitter, for transmitting an ultrasonic signal to the user; and
an ultrasonic detector, for receiving reflection signals of the user at the base point via an ultrasonic sensing method, to detect the distance between the base point and the user.

4. The driving device of claim 1, wherein the distance detection module is an electromagnetic energy detector, for sensing electromagnetic energy of the user at the base point via an electromagnetic sensing method, to detect the distance between the base point and the user.

5. The driving device of claim 1, wherein the distance detection module is an optical detector, for sensing optical reflections or fluctuations of the user at the base point via an optical sensing method, to detect the distance between the base point and the user.

6. The driving device of claim 1, wherein the control module adjusts a size of a picture demonstrated by the flat panel display according to the detection result.

7. The driving device of claim 6, wherein when the detection result indicates that the distance between the base point and the user is greater than a predetermined value, the control module is utilized for magnifying the picture, and when the detection result indicates that the distance between the base point and the user is less than the predetermined value, the control module is utilized for minifying the picture.

8. The driving device of claim 1, wherein the control module adjusts a volume of an audio signal outputted by the flat panel display according to the detection result.

9. The driving device of claim 8, wherein when the detection result indicates that the distance between the base point and the user is greater than a predetermined value, the control module is utilized for increasing the volume of the audio signal, and when the detection result indicates that the distance between the base point and the user is less than the predetermined value, the control module is utilized for reducing the volume of the audio signal.

10. The driving device of claim 1, wherein the flat panel display is a liquid crystal display (LCD), and the control module is further utilized for controlling backlights of the LCD.

11. A driving method for a flat panel display, comprising:
detecting a distance between a base point of a housing of the flat panel display and a user, to generate a detection result; and
adjusting output effects of the flat panel display according to the detection result.

12. The driving method of claim 11, wherein the step of detecting the distance between the base point and the user is sensing thermals of the user at the base point via an infrared sensing method, to detect the distance between the base point and the user.

13. The driving method of claim 11, wherein the step of detecting the distance between the base point and the user is transmitting an ultrasonic signal to the user, and receiving reflection signals of the user at the base point via an ultrasonic sensing method, to detect the distance between the base point and the user.

14. The driving method of claim 11, wherein the step of detecting the distance between the base point and the user is sensing electromagnetic energy of the user at the base point via an electromagnetic sensing method, to detect the distance between the base point and the user.

15. The driving method of claim 11, wherein the step of detecting the distance between the base point and the user is sensing optical reflections or fluctuations of the user at the base point via an optical sensing method, to detect the distance between the base point and the user.

16. The driving method of claim 11, wherein the step of adjusting the output effects of the flat panel display according to the detection result is adjusting a size of a picture demonstrated by the flat panel display according to the detection result.

17. The driving method of claim 16, further comprising magnifying the picture when the detection result indicates that the distance between the base point and the user is greater than a predetermined value and minifying the picture when the detection result indicates that the distance between the base point and the user is less than the predetermined value.

18. The driving method of claim 11, wherein the step of adjusting the output effects of the flat panel display according to the detection result is adjusting a volume of an audio signal of the flat panel display according to the detection result.

19. The driving method of claim 18, comprising increasing the volume of the audio signal when the detection result indicates that the distance between the base point and the user is greater than a predetermined value, and reducing the volume of the audio signal when the detection result indicates that the distance between the base point and the user is less than the predetermined value.

20. The driving method of claim 1, comprising controlling backlights of the flat panel display when the flat panel display is a liquid crystal display.

21. A flat panel display, comprising:
a housing;
a monitor;
a speaker;
an operating device, for receiving multimedia data and outputting contents of the multimedia data via the monitor and the speaker; and
a driving device, comprising:
a distance detection module, for detecting a distance between a base point of the housing and a user, to generate a detection result; and
a control module, for controlling the operating device according to the detection result, to adjust output effects of the monitor or the speaker.

22. The flat panel display of claim 21, wherein the distance detection module is an infrared detector for sensing thermals of the user at the base point via an infrared sensing method, to detect the distance between the base point and the user.

23. The flat panel display of claim 21, wherein the distance detection module comprises:
an ultrasonic transmitter, for transmitting an ultrasonic signal to the user; and
an ultrasonic detector, for receiving reflection signals of the user at the base point via an ultrasonic sensing method, to detect the distance between the base point and the user.

24. The flat panel display of claim 21, wherein the distance detection module is an electromagnetic energy detector for sensing electromagnetic energy of the user at the base point via an electromagnetic sensing method, to detect the distance between the base point and the user.

25. The flat panel display of claim 21, wherein the distance detection module is an optical detector for sensing optical reflections or fluctuations of the user at the base point via an optical sensing method, to detect the distance between the base point and the user.

26. The flat panel display of claim 21, wherein the control module controls the operating device to adjust a size of a picture demonstrated by the monitor according to the detection result.

27. The flat panel display of claim 26, wherein when the detection result indicates that the distance between the base point and the user is greater than a predetermined value, the control module is utilized for magnifying the picture, and when the detection result indicates that the distance between the base point and the user is less than the predetermined value, the control module is utilized for minifying the picture.

28. The flat panel display of claim 21, wherein the control module controls the operating device according to the detection result, to adjust a volume of an audio signal outputted by the speaker.

29. The flat panel display of claim 28, wherein when the detection result indicates that the distance between the base point and the user is greater than a predetermined value, the control module is utilized for increasing the volume of the audio signal, and when the detection result indicates that the distance between the base point and the user is less than the predetermined value, the control module is utilized for reducing the volume of the audio signal.

30. The flat panel display of claim 1, wherein the monitor is a liquid crystal display (LCD), and the control module is further utilized for controlling backlights of the LCD.
